(19) United States
(12) Patent Application Publication
(10) Pub. No.: US 2015/0192266 A1
(43) Pub. Date: Jul. 9, 2015

(54) VEHICLE HEADLAMP

(71) Applicant: Miguel AMBRONA ARNAIZ, Jaen (ES)

(72) Inventor: Miguel Ambrona Arnaiz, Jaen (ES)

(21) Appl. No.: 14/411,613

(22) PCT Filed: Jun. 25, 2013
(86) PCT No.: PCT/ES2013/070416

§ 371 Date: Dec. 29, 2014

(30) Foreign Application Priority Data
Jun. 29, 2012 (ES) U 201230714

(51) Int. Cl. F21S 8/10

(52) U.S. Cl. CPC F21S 48/31; F21S 48/1329; F21S 48/1225; F21Y 2101/02

(57) ABSTRACT

The front illumination source of a vehicle includes a headlamp having a casing with a supporting member for a light-emitting bulb. The headlamp is closed at the front by means of a transparent front element through which the light is emitted by the bulb. There may be, optionally, internal reflecting surfaces and lenses for achieving greater efficiency in terms of light projection. There is an inert gas enclosed inside the headlamp in a totally leaktight manner. The headlamp relates not only to automobiles but also to trucks, vans and even motorcycles.

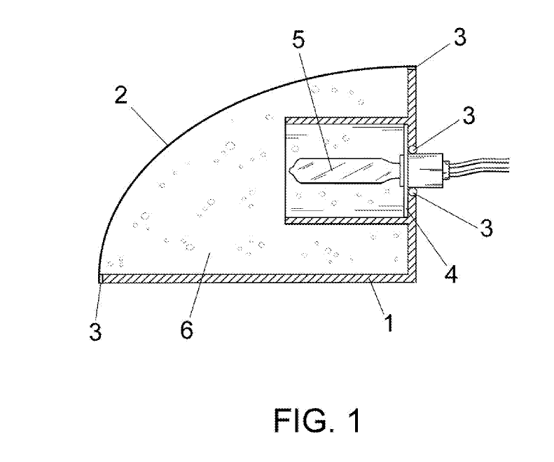

### OBJECT OF THE INVENTION

The present invention relates to a vehicle headlamp which may be used in automobiles, trucks, vans and even motorcycles. The headlamp preferably and fundamentally constitutes the front illumination source or front headlamp of a vehicle, not excluding the use thereof in other vehicle indicators.

The object of the invention is to achieve a headlamp of better quality than those that currently exist, which projects light more effectively for longer periods of time, in terms of the service life of the headlamp itself.

### BACKGROUND OF THE INVENTION

Vehicle headlamps are basically made up of a casing or main structure, inside which bulbs or light-emitting devices are housed, located opposite the front portion of the headlamp. This front portion is closed by a transparent wall made of glass or plastic through which the light emitted by the bulbs or emitting devices is projected.

Naturally, headlamps include other additional elements, as well as the basic elements described above, for example, the inner surface thereof tends to be mirrored in order to reflect light, inter alia.

Headlamps exist with small holes for air to enter into and come out of in order to facilitate internal cooling, thereby preventing the problems of condensation and vaporisation problems from arising inside the headlamp.

Nevertheless, traditional headlamps, especially those with holes, become less effective over time, given that these holes allow dust and dirt to enter and be deposited on the inner walls of the headlamp, thus considerably reducing reflection and likewise making the lenses headlamps dirty, thus distorting the light effects thereof and making the headlamp blurry.

In other words, the efficacy of headlamps is reduced very significantly over time.

Moreover, the cooling holes usually become blocked, thereby giving rise to water condensation and vaporisation problems since there is no longer any ventilation. This vaporisation and condensation thus gives rise to the bulbs fusing, which creates a layer of rust on the transparent front element, the amount of light projected thereby being reduced, etc.

It must also be noted that those headlamps that use LEDs as a light source cannot usually be replaced, thus meaning that if they fuse, the entire headlamp must be changed or the owner must visit a specialist garage in order to repair the anomaly. Fitting a new headlamp is expensive and time-consuming in terms of travelling to and from the garage, etc.

### DESCRIPTION OF THE INVENTION

The headlamp set out herein resolves the problems described above, using a simple but effective solution.

More specifically, the headlamp of the invention is unique in that inert gas is stored inside the same, being closed hermetically to form a definitive seal. Nevertheless, the headlamp may naturally be made in such a way that it is possible to open it and re-fill it with inert gas.

In any case, when the headlamp is filled with inert gas, such as nitrogen, in a leaktight atmosphere, said gas will always be pure, without dirt that may enter from outside and without water vapour produced as a result of condensation or evaporation caused by the air. Thus, the headlamp better transmits light since the gas it contains is completely pure, without particles of suspended dust from outside the headlamp and of course, without water vapour, which may distort the rays of light or cause the bulbs to fuse.

By virtue of all of the above, the headlamp performs homogeneously and consistently in comparison to traditional headlamps that gradually become less effective with time.

The fact that the headlamp contains an inert gas must likewise be pointed out, since this supports many temperature changes, thus protecting the bulbs, which are more difficult to fuse as a result of changes in temperature. The bulbs are prevented from fusing as a result of evaporation or water condensation as well.

Ultimately, the inventive headlamp projects light more effectively, whilst lasting longer in optimal operation conditions. Thus, the vehicle driver may benefit from better lighting, and as such, better safety.

The headlamp may of course be used regardless of the kind of bulb inserted, it being possible for LED type lights to be used, xenon type lights to be used, etc. In all cases, once the headlamp has been mounted, the same is closed hermetically with inert gas inside.

The headlamp may also have holes in it, which may be used as desired and which may be provided with leaktight stops or plugs in order to ensure the inner seal of the headlamp is not broken.

Finally, it is noted that the headlamp may be made up of various parts that may be coupled to one another, provided that they have leaktight adjustment and closure elements, in order to keep the inert gas inside.

In summary, a leaktight headlamp may be filled with nitrogen and/or other inert gasses, the optical quality of which is much greater than that of traditional headlamps and lasts longer, since it takes more time for the materials to wear, in turn extending the service life of the bulbs.

The manufacturer may decide on the pressure of inert gasses inside the headlamp, as they deem most appropriate.

The present invention relates not only to automobiles but also to trucks, vans and even motorcycles, constituting the front illumination source of the vehicle. The object of the invention is to achieve a headlamp of higher quality than current headlamps, that is more effective in terms of light projection and that lasts for a longer period of time in terms of the service life of the actual headlamp. To that end, and starting from the conventional structure involving a casing with a supporting member for the corresponding light-emitting bulb, while the headlamp is closed at the front by means of a transparent front element through which the light emitted by the corresponding bulb is projected, and there may be, optionally, within, reflecting surfaces and lenses for achieving greater efficiency in terms of light projection, the invention focuses on the fact that, within, there is an inert gas enclosed inside the headlamp in a totally leaktight manner.

### DESCRIPTION OF THE DRAWINGS

In order to complement the description below, with the aim of facilitating a better understanding of the invention characteristics, in accordance with a preferred exemplary practical embodiment thereof, said description is accompanied by one single drawing, which forms an intrinsic part thereof and constitutes a non-limiting illustration of the following:

The single FIGURE shown on this planning sheet corresponds to a schematic cross-sectional view of a vehicle headlamp with inert gas inside, all in accordance with the object of the invention.

### PREFERRED EMBODIMENT OF THE INVENTION

As can be seen in the FIGURE referred to, the headlamp of the invention is formed traditionally by a casing (1) with a transparent front element (2), an adjustment element being established between the casing and the front element (2) by means of a leaktight or airtight joint (3), the rear portion thereof having a support (4) for the corresponding light-emitting bulb (5).

As such, the headlamp assembly is unique in that it has an inert gas (6) inside, for example nitrogen, which is enclosed in a leaktight manner, thus preventing internal disturbance as experienced in traditional headlamps, for example condensation, dirt entering and vaporisation, etc., all of which not only reduces the service life of the bulb (5) in the headlamp in question but also of the assembly of the same, the transparent front element (2) becoming dirty and the brightness or intensity of the light emitted by the same being reduced. Using this inert gas, all of these problems may be prevented such that the headlamp may be much more effective and the service life of the headlamp may also be extended.

The headlamp may have gas input and output holes in its casing, which would be leaktight inside as a result of a number of stops or plugs which may be placed therein, and which may make it possible to leave the inside of the headlamp completely leaktight from the outside.

Ultimately, the invention constitutes a headlamp, the inside of which is sealed leaktight and contains an inert gas (6), such as nitrogen or other inert gases, in order to prevent the characteristics of the materials that form the headlamp assembly from being affected, and upon the inside being leaktight, preventing dirt from entering into the headlight from outside.

Furthermore, since there is no oxygen inside, but rather only inert gas (6), the materials do not rust, thereby meaning the bulb (5) has a longer service life.

Finally, the optical quality of the headlamp is benefited by the gases housed therein, since the transparent front element (2) and even the lenses and internal reflecting surfaces built into the headlamps are always kept completely clean.

1. A vehicle headlamp, which, being of the variety formed by a casing with a support for the corresponding light-emitting bulb, whilst being closed at the front by means of a transparent front element through which light emitted by the corresponding bulb is projected, it being possible for it to have internal reflecting surfaces and lenses, in order to achieve greater efficacy when projecting light, is characterised in that it has an inert gas inside, which is closed inside the headlamp in a completely leaktight manner.

2. The vehicle headlamp according to claim 1, characterised in that the headlamp assembly is likely to be made up of various parts that may be coupled to one another in a completely leaktight manner, in order to keep the inert gas inside hermetically.

3. The vehicle headlamp according to claim 1, characterised in that the headlamp is likely to have holes through which gases can be input and output, these holes being accompanied by leaktight closure stops, in order to keep the inert gas enclosed hermetically inside the headlamp itself.

4. The vehicle headlamp according to claim 1, wherein the inert gas comprises nitrogen.

5. A vehicle headlamp, comprising:
a light-emitting element;
a casing including a front opening, the casing supporting the light-emitting element such that the light-emitting element is configured to emit light in at least a forward direction through the front opening;
a transparent front element sealing the front opening in an air-tight manner such that the front element and the casing define a chamber therebetween, the light-emitting element being disposed in the chamber; and
an inert gas sealed inside the chamber.

6. The vehicle headlamp according to claim 5, wherein the inert gas is hermetically sealed inside the chamber.

7. The vehicle headlamp according to claim 5, wherein at least one of the casing the transparent front element includes a throughhole configured to enable gases to be input into the chamber or output from the chamber, the headlamp further comprising a plug disposed in the throughhole and configured to keep the inert gas enclosed hermetically inside the chamber.

8. The vehicle headlamp according to claim 5, wherein the inert gas comprises nitrogen.

9. The vehicle headlamp according to claim 5, wherein an inner surface of the casing is reflective.

10. The vehicle headlamp according to claim 5, wherein the transparent front element includes a lens.
